(19) United States
(12) Patent Application Publication
(10) Pub. No.: US 2011/0170627 A1
(43) Pub. Date: Jul. 14, 2011

(54) METHOD FOR GENERATING PREAMBLE IN MULTI-USER MULTI-INPUT MULTI-OUTPUT SYSTEM, AND DATA TRANSMISSION APPARATUS AND USER TERMINAL USING THE METHOD

(76) Inventors: Ui Kun Kwon, Hwaseong-si (KR); Young Soo Kim, Seoul (KR)

(21) Appl. No.: 13/005,056

(22) Filed: Jan. 12, 2011

(30) Foreign Application Priority Data
Jan. 12, 2010 (KR) 10-2010-0002541

(51) Int. Cl. H04L 27/00

(52) U.S. Cl. 375/295

(57) ABSTRACT

Provided are a method for generating a preamble included in a frame of a Multi-User Multi-Input Multi-Output (MU-MIMO) system, and a data transmission apparatus and terminal in which the method is adopted. The data transmission apparatus may enable at least one Very High Throughput-Long Training Field (VHT-LTF) sequence to be included in at least one Space Time Stream (STS) transmitted to at least one terminal, and transmits the at least one VHT-LTF sequence. The at least one VHT-LTF sequence may have the same length as another VHT-LTF sequence simultaneously transmitted.

### CROSS-REFERENCE TO RELATED APPLICATION(S)

This application claims the benefit under 35 U.S.C. §119(a) of Korean Patent Application No. 10-2010-0002541, filed on Jan. 12, 2010, in the Korean Intellectual Property Office, the entire disclosure of which is incorporated herein by reference for all purposes.

### BACKGROUND

1. Field

The following description relates to a method for generating a preamble included in a transmission frame of a Multi-User Multi-Input Multi-Output (MU-MIMO) system, and to a data transmission apparatus and terminal using the method.

2. Description of Related Art

A data throughput may be one of the important issues in radio communication. In particular, in a case of a Local Area Network (LAN), an improvement of the throughput may become a more important issue due to an increase in a number of users and in various applications using voice, video streaming, and the like.

To improve the data throughput, a method of increasing a bandwidth of a channel may be used. However, there is a limitation to the amount of increase of the bandwidth of the channel due to a limited frequency resource. Thus, recently, a Multi Input Multi Output (MIMO) technology has been actively studied to improve the data throughput without an increase in the frequency resource, and has been adopted in a radio LAN-related standard such as 802.11n and in mobile communication standards such as the Third Generation Partnership Project Long Term Evolution (3GPP LTE), IEEE 802.16e, and the like.

Due to an increase in a number of users that access a mobile communication network and an increase in a number of adoptive applications, a user distribution and traffic characteristics between users have been diversified. Also, the importance in providing the adoptive applications and a Quality of Service (QoS) between users has become further highlighted. Thus, there is a demand for a multiple access technology that may flexibly allocate, to users, an improved data throughput obtained by adopting a widened channel bandwidth and the MIMO technology.

Recently, in response to this demand, a Multi-User MIMO (MU-MIMO) method has been suggested that may share radio resources by simultaneously transmitting, by a single transmission apparatus, mutually different signals to a plurality of stations (STAs). The MU-MIMO method has been adopted in the 802.16m standard and an LTE-Advanced standard, which are next generation mobile communication standards, and the adoption of the MU-MIMO method even in the 802.11ac standard, that is, a next generation radio LAN technology, may be positively considered.

### SUMMARY

In one general aspect, there is provided a data transmission apparatus, which enables at least one Very High Throughput-Long Training Field (VHT-LTF) sequence to be included in at least one Space Time Stream (STS) transmitted to at least one terminal, and transmits the at least one VHT-LTF sequence, the at least one VHT-LTF sequence having a same length as another VHT-LTF sequence simultaneously transmitted.

The at least one VHT-LTF sequence may be configured using a same orthogonal matrix with respect to the at least one terminal.

The at least one VHT-LTF sequence may be generated using an orthogonal matrix satisfying a predetermined condition, and a number of rows of the orthogonal matrix and/or a number of columns of the orthogonal matrix may be the same as a number of the at least one STS transmitted to each of the at least one terminal.

Rows of the orthogonal matrix and/or columns of the orthogonal matrix may be created in a predetermined order.

The at least one VHT-LTF sequence may be generated using an orthogonal matrix satisfying a predetermined condition, and the at least one VHT-LTF sequence may be generated using rows of the orthogonal matrix and/or columns of the orthogonal matrix.

The at least one STS may further include a VHT-signal (VHT-SIG) field classified for each of the at least one terminal, and the VHT-SIG field may be precoded in a Space Division Multiple Access (SDMA) method.

The VHT-SIG field may include length information of a data field included in the at least one STS transmitted to the at least one terminal.

The at least one STS may further include frame padding to adjust a basic transmission unit of a data field.

The at least one STS may further include a VHT-SIG field to be common to the at least one terminal, and the VHT-SIG field includes length information of the VHT-LTF sequence.

The STS may further include a Legacy signal (L-SIG) field to be common to the at least one terminal, and the L-SIG field includes length information of a frame subsequent to the L-SIG field.

In another general aspect, there is provided a method of communication used by a transmitter and terminals, the method including generating one or more streams for each of the terminals, each stream including Very High Throughput-Long Training Fields (VHT-LTFs) and a data field, at least one of the one or more streams for each of the terminals including a Very High Throughput-Signal (VHT-SIG) field having length information of the data field, and transmitting to each of the terminals the one or more streams for each of the terminals.

A length of the VHT-LTFs in each stream may be the same.

The VHT-LTFs, the VHT-SIG, and the data field may be precoded using a Space Division Multiple Access Method.

In another general aspect, there is provided a method of communication used by a terminal in a multi-user multi-input multi-output system, the method including receiving one or more streams from a transmitter, each stream including Very High Throughput-Long Training Fields (VHT-LTFs) and a precoded data field, at least one of the one or more streams including a Very High Throughput-Signal (VHT-SIG) field having length information of the data field, and decoding the precoded data field of each stream using the VHT-LTFs and the VHT-SIG.

A length of the VHT-LTFs in each stream may be the same.

The VHT-LTFs and the VHT-SIG may be precoded.

In another general aspect, there is provided a data transmission apparatus including a generation unit to generate at least one Very High Throughput-Long Training Field (VHT-LTF) sequence to be included in at least one Space Time Stream (STS) transmitted to at least one terminal, and a transmission unit to simultaneously transmit the at least one STS in a plurality of STSs, wherein the at least one VHT-LTF sequence has a same length as another VHT-LTF sequence included in another STS of the transmitted plurality of STSs.

The at least one STS may further include frame padding to adjust the length of the at least one VHT-LTF sequence.

In another general aspect, there is provided a method of communicating between a transmitter and a plurality of terminals, the method including generating, at the transmitter, one or more streams to be transmitted to each of the respective terminals, wherein each stream includes a same length of Very High Throughput-Long Training Fields (VHT-LTFs).

The VHT-LTFs may be precoded using the Space Division Multiple Access Method.

Other features and aspects will be apparent from the following detailed description, the drawings, and the claims.

### BRIEF DESCRIPTION OF THE DRAWINGS

FIG. 1 is a diagram illustrating an example of a structure of a frame supporting Multi-User Multi-Input Multi-Output (MU-MIMO).

FIG. 2 is a diagram illustrating an example of a frame transmission using an MU-MIMO method.

FIG. 3 is a diagram illustrating an example structure of a Space Time Stream (STS) of a frame supporting MU-MIMO.

FIG. 4 is a block diagram illustrating an example structure of a data transmission apparatus.

FIG. 5 is a block diagram illustrating an example structure of a station (STA).

FIG. 6 is a flowchart illustrating an example data transmission method of a data transmission apparatus.

### DETAILED DESCRIPTION

The following detailed description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. The progression of processing operations described is an example. The sequence of operations is not limited to that set forth herein and may be changed as is known in the art, with the exception of operations necessarily occurring in a certain order. Also, descriptions of well-known functions and constructions may be omitted for increased clarity and conciseness.

Throughout the drawings and the detailed description, unless otherwise described, the same drawing reference numerals will be understood to refer to the same or like elements, features, and structures. The relative size and depiction of elements may be exaggerated for clarity, illustration, and convenience.

In the present examples, a preamble structure of a frame supporting Multi-User Multi-Input Multi-Output (MU-MIMO) and transmission control information are disclosed. An MU-MIMO communication system may adopt a Space Division Multiple Access (SDMA) method, so that a single transmission apparatus may simultaneously transmit, to at least one station (STA), at least one frame that is unique among simultaneously transmitted signals. When using the preamble structure according to various examples, channel information of various Space Time Streams (STSs) having been SDMA precoded and simultaneously transmitted may be estimated. The preamble structure according to various examples may be applicable in all communication systems in which a transmission apparatus having at least one antenna transmits a frame to at least one STA having at least one antenna.

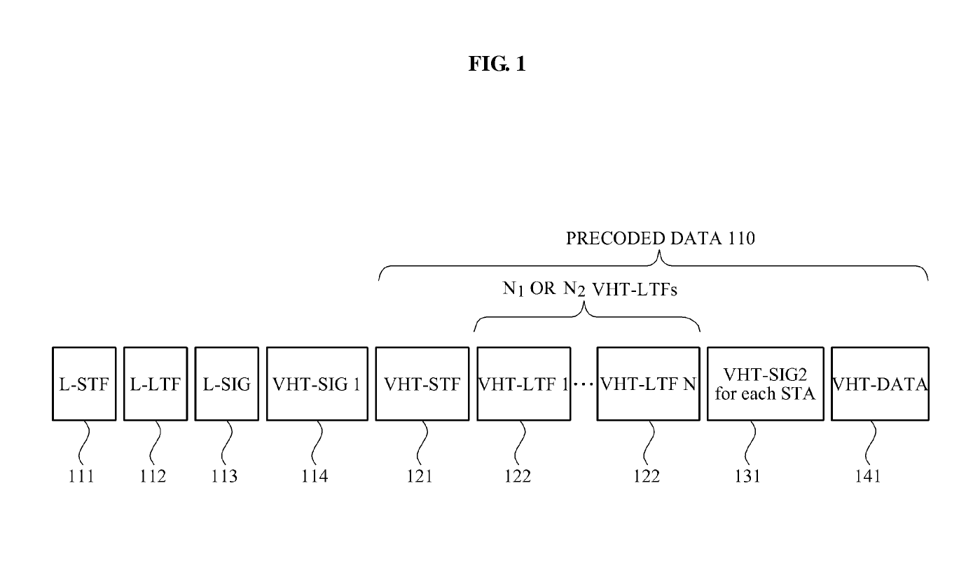

FIG. 1 illustrates an example of a frame structure that may support MU-MIMO. The frame structure illustrated in FIG. 1 may be applicable in the 802.11 ac standard.

The first three fields 111 to 113 (L-STF, L-LTF, and L-SIG) of the example MU-MIMO frame structure may be the same as, or similar to, the first three fields of a frame structure that may support a terminal included in the 802.11n standard, which added MIMO to the physical layer. This type of terminal, which may have been configured outside of the MU-MIMO standard, is referred to in this description as a “legacy terminal.” The L-STF 111 may signify a Legacy Short Training Field (L-STF), the L-LTF 112 may signify a Legacy Long Training Field (L-LTF), and the L-SIG 113 may signify a Legacy signal field (L-SIG). Using the three fields 111 to 113, legacy terminals (e.g., IEEE 802.11a/g/n) not supporting MU-MIMO, as well as terminals supporting MU-MIMO, may receive a part of a frame. In particular, the L-SIG 113 may include frame length information ranging from a Very High Throughput (VHT)-SIG1 114 to the end of the frame, so that legacy terminals may determine length information of a corresponding frame.

The VHT-SIG1 114 may be a signal-field transmitted for 802.11ac terminals (STAs) that support MU-MIMO, and may include common control information commonly corresponding to a frame to be currently transmitted. Fields 110 subsequent to the VHT-SIG1 114 may be precoded to be decoded by the respective STAs at which the information in those fields is intended to be received, although the frames may be transmitted to each of the STAs, and the precoding may be performed in an SDMA method.

A VHT-STF 121 may be a preamble to assist an Automatic Gain Control (AGC) setting of power amplifiers of the STAs supporting MU-MIMO. A number of VHT-STF 121 equal to the number of transmitted STSs may be transmitted, and the same precoding as that of the SDMA method applied to data fields may be applied to the VHT-STF 121 and transmitted to each of the STAs.

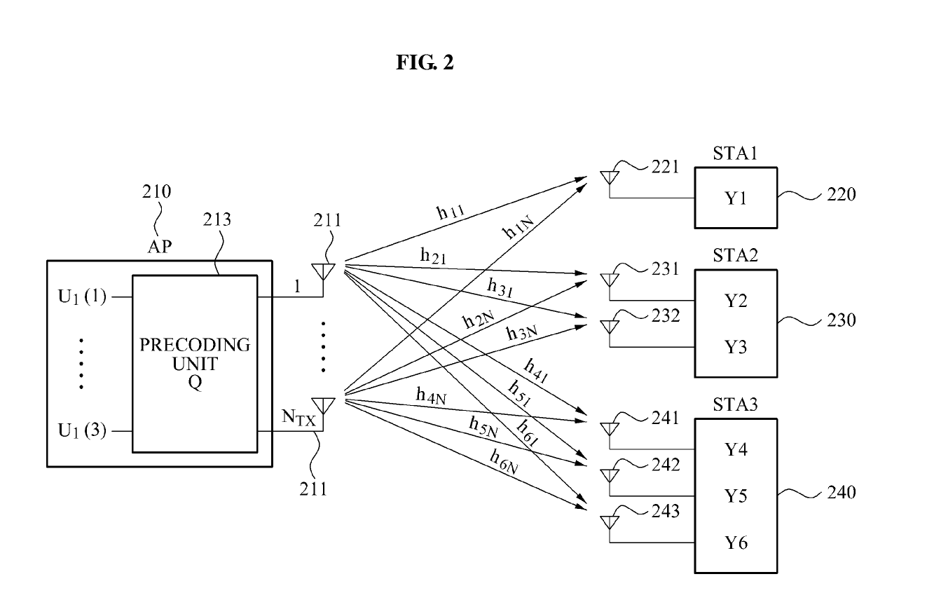

VHT-LTFs 122 may be preambles used in a channel estimation of the MU-MIMO system. Hereinafter, two Examples 1 and 2 will be described with reference to FIG. 2. Examples 1 and 2 are referred to as such simply to aid the description of these particular examples, and the UM-MIMO frame transmission is not limited to these examples.

FIG. 2 illustrates an example of a frame transmission using an MU-MIMO method. Referring to FIG. 2, an Access Point (AP) 210 has a number N_{TX} of transmission antennas 211, and a frame precoded in a precoding unit 213 is transmitted to an STA1 220, an STA2 230, and an STA3 240. According to an example, the STA1 220 may have a single reception antenna 221, the STA2 230 may have two reception antennas 231 and 232, and the STA3 240 may have three reception antennas 241 to 243. The various numbers of antennas in the STAs of this example are merely used as example quantities, and are not limited to those presented in this example.

A frame transmitted from the transmission antennas 211 of the AP 210 may pass through various channels h₁₁ to h_{N6}, and may be received in reception antennas 221, 231, 232, 241, 242, and 243 of the respective STAs 220, 230, and 240. The possible channels in this configuration are not limited to those illustrated in FIG. 2. As another example, various channels may include those in which a signal is reflected from a reflective surface between a transmitting and receiving antenna.

Referring again to FIG. 2, the channel h_{6N} denotes a channel between the N-th antenna of the AP 210 and the antenna 243 of the STA 240. Thus, the AP 210 transmits a stream from the N-th antenna 211 to the antenna 243 of the STA 240 through the channel h_{6N}. In FIG. 2, it is assumed in this example that the AP 210 transmits a single STS, two STSs, and three STSs to the STA1 220, the STA 2 230, and the STA3 240, respectively. In this instance, a maximum value of the STSs transmitted to the STAs 220, 230, and 240 is three, and a sum of the STSs is six.

### Example 1

### LTF Structure Depending on a Maximum Value in the Number of STSs for Each STA

Example 1 may relate to a structure of a VHT-LTF that is designed to enable the VHT-LTFs 122 to be dependent on a maximum value of the number of STSs transmitted to the STAs. In Example 1, an overhead of a preamble may be relatively less.

An example of the VHT-LTFs 122 according to Example 1 may be expressed as the following Equation 1.

$${[ VHT \text{-} LTF 1 VHT \text{-} LTF 2 … VHT \text{-} {LTFN}_{1} ]}_{{N}_{STS} \times {N}_{1}} = {P}_{{N}_{STS} \times {N}_{1}} \times {T}_{{N}_{1} \times {N}_{1}} = {[ \begin{matrix}{U}_{1} ( 1 ) \\ ⋮ \\ {U}_{1} ( {N}_{STS} ( 1 ) ) \\ {U}_{1} ( 1 ) \\ ⋮ \\ {U}_{1} ( {N}_{STS} ( 2 ) ) \\ ⋮ \\ {U}_{1} ( 1 ) \\ ⋮ \\ {U}_{1} ( {N}_{STS} ( K ) )\end{matrix} ]}_{{N}_{STS} \times {N}_{1}} \times {[ \begin{matrix}{t}_{1} & 0 & 0 & 0 \\ 0 & {t}_{2} & 0 & 0 \\ 0 & ⋮ & ⋱ & ⋮ \\ 0 & 0 & 0 & {t}_{{N}_{1}}\end{matrix} ]}_{{N}_{1} \times {N}_{1}} \qquad [ Equation 1 ]$$

In Equation 1, VHT-LTFn denotes a column vector of the VHT-LTF having a length N_{STS} which is transmitted to the n-th time slot, U₁ denotes an orthogonal matrix having a dimension of N₁×N₁, U₁(1) denotes the first row of U₁, and tᵢ denotes a training sequence applied to each of VHT-LTF time slots. Also, K denotes a total number of STAs to which a frame is transmitted, N_{STS}(i) denotes a number of STSs transmitted to the i-th STA, N_{STS} denotes a total number of transmitted STSs, and N₁ denotes a number of time slots of a transmitted VHT-LTF.

As shown in Equation 1, each of rows of the matrix P may be obtained from the matrix U₁, and a type of the matrix P may be determined in accordance with a number of STSs transmitted to each STA. Rows of the matrix P corresponding to the i-th STA may be configured of N_{STS}(i) numbered rows of U₁.

In a case in which the structure of the VHT-LTF of Example 1 is applied in FIG. 2, the three STAs 220, 230, and 240 may exist as illustrated in FIG. 2, and a single STS, two STSs, and three STSs may be transmitted to a corresponding STA, respectively. In Equation 1, it is assumed that a 4×4 Walsh-Hadamard matrix similar to Equation 2 below is used as the matrix U₁.

$$\begin{matrix}{U}_{1} = ( 4 \times 4 ) Walsh \text{-} Hadamard Matrix \\ = [ \begin{matrix}{U}_{1} ( 1 ) \\ {U}_{1} ( 2 ) \\ {U}_{1} ( 3 ) \\ {U}_{1} ( 4 )\end{matrix} ] \\ = [ \begin{matrix}1 & 1 & 1 & 1 \\ 1 & - 1 & 1 & - 1 \\ 1 & 1 & - 1 & - 1 \\ 1 & - 1 & - 1 & 1\end{matrix} ]\end{matrix} \qquad [ Equation 2 ]$$

In Equation 2, since the matrix U₁ is a unitary matrix and a number of STSs transmitted to the STA3 240 is 3, a 4×4 matrix may be obtained in accordance with 3, that is, a maximum value. In this case, the structure of the VHT-LTF may be represented as the following Equation 3.

$${[ VHT \text{-} LTF 1 … VHT \text{-} LTF 4 ]}_{6 \times 4} = [ \begin{matrix}{U}_{1} ( 1 ) \\ {U}_{1} ( 1 ) \\ {U}_{1} ( 2 ) \\ \begin{matrix}{U}_{1} ( 1 ) \\ {U}_{1} ( 2 ) \\ {U}_{1} ( 3 )\end{matrix}\end{matrix} ] \times [ \begin{matrix}{t}_{1} & 0 & 0 & 0 \\ 0 & {t}_{2} & 0 & 0 \\ 0 & 0 & {t}_{3} & 0 \\ 0 & 0 & 0 & {t}_{4}\end{matrix} ] = [ \begin{matrix}1 & 1 & 1 & 1 \\ 1 & 1 & 1 & 1 \\ 1 & - 1 & 1 & - 1 \\ 1 & 1 & 1 & 1 \\ 1 & - 1 & 1 & - 1 \\ 1 & 1 & - 1 & - 1\end{matrix} ] \times [ \begin{matrix}{t}_{1} & 0 & 0 & 0 \\ 0 & {t}_{2} & 0 & 0 \\ 0 & 0 & {t}_{3} & 0 \\ 0 & 0 & 0 & {t}_{4}\end{matrix} ] \qquad [ Equation 3 ]$$

In a 6×4 matrix within Equation 3, the first row may support the STA1 220, the second and third rows may support the STA2 230, and the remaining three rows may support the STA3 240. In this manner, a VHT-LTF sequence included in the STS transmitted to each of the STAs 220, 230, and 240 may be configured. The VHT-LTF sequence may be configured using the same orthogonal matrix with respect to all STAs. Also, a number of rows or columns of the orthogonal matrix used to configure the VHT-LTF sequence of each STA may be the same as a number of STSs transmitted to each of the STAs 220, 230, and 240, and the rows or columns of the orthogonal matrix may be determined in a predetermined order.

In the case of Example 1, each of the STAs 220, 230, and 240 may share a specific row of a single orthogonal matrix U₁. Specifically, each of the STAs 220, 230, and 240 may decode a VHT-SIG 2 even without information about STS allocation, so that a required bit value of a VHT-SIG1 used to describe the STS allocation may be reduced.

An example using the structure of the VHT-LTF of Example 1 will be further described with reference to FIG. 2. Transmission signals (Tx_signals) transmitted through each of the transmission antennas 211 in the AP 210 may be obtained by the following Equation 4.

$$Tx\_signals = {[ {Q}_{1} {Q}_{2} … {Q}_{k} ]}_{{N}_{TX} \times {N}_{STS}} \times [ \begin{matrix}{N}_{STS} ( 1 ) STS for STA 1 \\ {N}_{STS} ( 2 ) STS for STA 2 \\ ⋮ \\ {N}_{STS} ( K ) STS for STA K\end{matrix} ] \qquad [ Equation 4 ]$$

In Equation 4, Qₖ denotes an N_{TX}×N_{STS[k]} SDMA steering matrix for the k-th STA, and N_{TX} denotes a number of transmission antennas.

Receiving signals (Rx_signals) received in each of the STAs 220, 230, and 240 may be expressed as the following Equation 5.

$$[ \begin{matrix}Y 1 \\ \begin{matrix}Y 2 \\ Y 3\end{matrix} \\ Y 4 \\ Y 5 \\ Y 6\end{matrix} ] = [ \begin{matrix}\begin{matrix}h 11 & h 12 & h 13 & h 14 & h 15 & h 16\end{matrix} \\ \begin{matrix}h 21 & h 22 & h 23 & h 24 & h 25 & h 26 \\ h 31 & h 32 & h 33 & h 34 & h 35 & h 36\end{matrix} \\ \begin{matrix}h 41 & h 42 & h 43 & h 44 & h 45 & h 46 \\ h 51 & h 52 & h 53 & h 54 & h 55 & h 56 \\ h 61 & h 62 & h 63 & h 64 & h 65 & h 66\end{matrix}\end{matrix} ] [ \begin{matrix}{Q}_{11} & {Q}_{21} & {Q}_{22} & {Q}_{31} & {Q}_{32} & {Q}_{33}\end{matrix} ] [ \begin{matrix}{U}_{1} ( 1 ) \\ {U}_{1} ( 1 ) \\ {U}_{1} ( 2 ) \\ {U}_{1} ( 1 ) \\ {U}_{1} ( 2 ) \\ {U}_{1} ( 3 )\end{matrix} ] \qquad [ Equation 5 ]$$

In Equation 5, in case of the STA2 230, Y2 and Y3 may correspond to receiving signals of the STA2 230. As shown in Equation 6 below, to estimate a channel of precoded data 110 where the SDMA is applied, the STA2 230 may perform a transpose operation on the receiving signals Y2 and Y3, and multiply the receiving signals where the transpose operation is performed, by the unitary matrix U₁.

$$\begin{matrix}{[ \begin{matrix}{U}_{1} ( 1 ) \\ {U}_{1} ( 2 ) \\ {U}_{1} ( 3 ) \\ {U}_{1} ( 4 )\end{matrix} ] [ \begin{matrix}Y 2 \\ Y 3\end{matrix} ]}^{T} = [ \begin{matrix}{U}_{1} ( 1 ) \\ {U}_{1} ( 2 ) \\ {U}_{1} ( 3 ) \\ {U}_{1} ( 4 )\end{matrix} ] [ {{U}_{1} ( 1 )}^{T} {{U}_{1} ( 1 )}^{T} … {{U}_{1} ( 3 )}^{T} ] \\ [ \begin{matrix}{Q}_{11}^{T} \\ {Q}_{21}^{T} \\ {Q}_{22}^{T} \\ {Q}_{31}^{T} \\ {Q}_{32}^{T} \\ {Q}_{33}^{T}\end{matrix} ] [ \begin{matrix}h 21 & h 31 \\ h 22 & h 32 \\ h 23 & h 33 \\ h 24 & h 34 \\ h 25 & h 35 \\ h 26 & h 36\end{matrix} ] \\ = [ \begin{matrix}1 & 1 & 0 & 1 & 0 & 0 \\ 0 & 0 & 1 & 0 & 1 & 0 \\ 0 & 0 & 0 & 0 & 0 & 1 \\ 0 & 0 & 0 & 0 & 0 & 0\end{matrix} ] [ \begin{matrix}0 & 0 \\ h 21 \_eq & 0 \\ 0 & h 22 \_eq \\ 0 & 0 \\ 0 & 0 \\ 0 & 0\end{matrix} ] \\ = [ \begin{matrix}h 21 \_eq & 0 \\ 0 & h 22 \_eq \\ 0 & 0 \\ 0 & 0\end{matrix} ]\end{matrix} \qquad [ Equation 6 ]$$

As shown in Equation 6, the STA2 230 may obtain an equivalent channel value of h₂₁_{_{—}}eq and h₂₂_{_{—}}eq, and the VHT-SIG2 131 and the VHT-DATA 141 each corresponding to the STA2 230 may be restored using the obtained equivalent channel value. Here, h₂₁_{_{—}}eq denotes the equivalent channel for the 1st stream of STA2, Similarly, h₂₂_{_{—}}eq denotes the equivalent channel for the 2nd stream of STA2.

### Example 2

### LTF Structure Depending on a Sum of the Number of STSs for Each STA

Example 2 may relate to a VHT-LTF structure that is designed to enable the VHT-LTFs 122 to be dependent on a sum of the number of STSs transmitted to each STA. In Example 2, an overhead of a preamble may be greater than that of Example 1, so that interference among the STAs 220, 230, and 240 may be considered.

An example of the VHT-LTFs 122 according to Example 2 may be expressed as the following Equation 7.

$${[ VHT \text{-} LTF 1 VHT \text{-} LTF 2 … VHT \text{-} {LTFN}_{1} ]}_{{N}_{STS} \times N 2} = {P}_{{N}_{STS} \times N 2} \times {T}_{{N}_{2} \times {N}_{2}} = {[ \begin{matrix}{U}_{2} ( 1 ) \\ ⋮ \\ {U}_{2} ( {N}_{STS} )\end{matrix} ]}_{{N}_{STS} \times {N}_{2}} \times [ \begin{matrix}{t}_{1} & 0 & 0 & 0 \\ 0 & {t}_{2} & 0 & 0 \\ 0 & ⋮ & ⋱ & ⋮ \\ 0 & 0 & 0 & {t}_{{N}_{2}}\end{matrix} ] \qquad [ Equation 7 ]$$

In Equation 7, VHT-LTFn denotes a column vector of the VHT-LTF having a length N_{STS} which is transmitted to the n-th time slot, U₂ denotes an orthogonal matrix having a dimension of N₂×N₂, U₂(1) denotes the first row of U₂, and tᵢ denotes a training sequence applied to each of VHT-LTF time slots. N₂ may have a value of more than N_{STS}. In this instance, N_{STS} denotes the total number of transmitted STSs, and N₂ denotes the number of time slots of a transmitted VHT-LTF.

As shown in Equation 7, the matrix P may be configured of N_{STS} matrices of the matrix U₂. The structure of the VHT-LTF of Equation 7 may require relatively greater channel estimation overhead in comparison with the structure of the VHT-LTF of Equation 1. Also, the STAs may ideally know in advance rows of the matrix P included in each of the STAs. In the structure of the VHT-LTF shown in Equation 7, since VHT-LTF STSs corresponding to all STSs have mutual orthogonality, the channel estimation may be more accurately performed, and interference signal information from STSs transmitted to another STA may be also estimated.

A case in which the structure of the VHT-LTF of Example 2 is applied in FIG. 2 will be herein described. As illustrated in FIG. 2, three STAs 220, 230, and 240 may exist, and a single STS, two STSs, and three STSs may be respectively transmitted to each of the STAs. In Equation 7, it is assumed that an 8×8 Walsh-Hadamard matrix like Equation 8 below is used as the matrix U₂.

$$\begin{matrix}{U}_{2} = ( 8 \times 8 ) Walsh \text{-} Hadamard Matrix \\ = [ \begin{matrix}{U}_{2} ( 1 ) \\ {U}_{2} ( 2 ) \\ {U}_{2} ( 3 ) \\ \begin{matrix}{U}_{2} ( 4 ) \\ {U}_{2} ( 5 ) \\ {U}_{2} ( 6 ) \\ {U}_{2} ( 7 ) \\ {U}_{2} ( 8 )\end{matrix}\end{matrix} ] \\ = [ \begin{matrix}1 & 1 & 1 & 1 & 1 & 1 & 1 & 1 \\ 1 & - 1 & 1 & - 1 & 1 & - 1 & 1 & - 1 \\ 1 & 1 & - 1 & - 1 & 1 & 1 & - 1 & - 1 \\ 1 & - 1 & - 1 & 1 & 1 & - 1 & - 1 & 1 \\ 1 & 1 & 1 & 1 & - 1 & - 1 & - 1 & - 1 \\ 1 & - 1 & 1 & - 1 & - 1 & - 1 & - 1 & 1 \\ 1 & 1 & - 1 & - 1 & - 1 & - 1 & 1 & 1 \\ 1 & - 1 & - 1 & 1 & - 1 & 1 & 1 & - 1\end{matrix} ]\end{matrix} \qquad [ Equation 8 ]$$

In Equation 8, since the matrix U₂ is a unitary matrix and a sum of transmitted STSs is six, an 8×8 matrix may be expressed as a 2^{N} square matrix supporting six STAs. In this case, the structure of the VHT-LTF may be represented as the following Equation 9.

$${[ VHT \text{-} LTF 1 … VHT \text{-} LTF 4 ]}_{6 \times 8} = [ \begin{matrix}{U}_{2} ( 1 ) \\ {U}_{2} ( 2 ) \\ {U}_{2} ( 3 ) \\ \begin{matrix}{U}_{2} ( 4 ) \\ {U}_{2} ( 5 ) \\ {U}_{2} ( 6 )\end{matrix}\end{matrix} ] \times [ \begin{matrix}{t}_{1} & 0 & 0 & 0 \\ 0 & {t}_{2} & 0 & 0 \\ 0 & ⋮ & ⋱ & ⋮ \\ 0 & 0 & 0 & {t}_{8}\end{matrix} ] = [ \begin{matrix}1 & 1 & 1 & 1 & 1 & 1 & 1 & 1 \\ 1 & - 1 & 1 & - 1 & 1 & - 1 & 1 & - 1 \\ 1 & 1 & - 1 & - 1 & 1 & 1 & - 1 & - 1 \\ 1 & - 1 & - 1 & 1 & 1 & - 1 & - 1 & 1 \\ 1 & 1 & 1 & 1 & - 1 & - 1 & - 1 & - 1 \\ 1 & - 1 & 1 & - 1 & - 1 & 1 & - 1 & 1\end{matrix} ] \times [ \begin{matrix}{t}_{1} & 0 & 0 & 0 \\ 0 & {t}_{2} & 0 & 0 \\ 0 & ⋮ & ⋱ & ⋮ \\ 0 & 0 & 0 & {t}_{8}\end{matrix} ] \qquad [ Equation 3 ]$$

In a 6×8 matrix within Equation 9, the first row may support Y1 of the STA1 220, the second and third rows may support Y2 and Y3 of the STA2 230, and the remaining three rows may support Y4 to Y6 of the STA3 240.

In this manner, a VHT-LTF sequence included in the STS transmitted to each of the STAs 220, 230, and 240 may be configured. In particular, the VHT-LTF sequence may be configured using mutually different rows or columns of a single orthogonal matrix.

In the case of Example 2, each of the STAs 220, 230, and 240 may use mutually different rows of the single orthogonal matrix U₂. Also, each of the STAs 220, 230, and 240 may estimate interference on a corresponding STA that is exerted by other STAs. There may be a desire to identify which STS is allocated to which STA. However, various methods for this identification may be used, and thus, further descriptions thereof will be herein omitted.

In Equation 2 used in Example 1, and in Equation 8 used in Example 2, a Walsh-Hadamard matrix may be used as the matrix U₁ and the matrix U₂, however, any type of orthogonal matrix satisfying a size condition of N₁ and N₂ may be used.

The VHT-LTFs described in Example 1 and Example 2 may be SDMA precoded to be transmitted to, and be accordingly decoded by, the respective STAs.

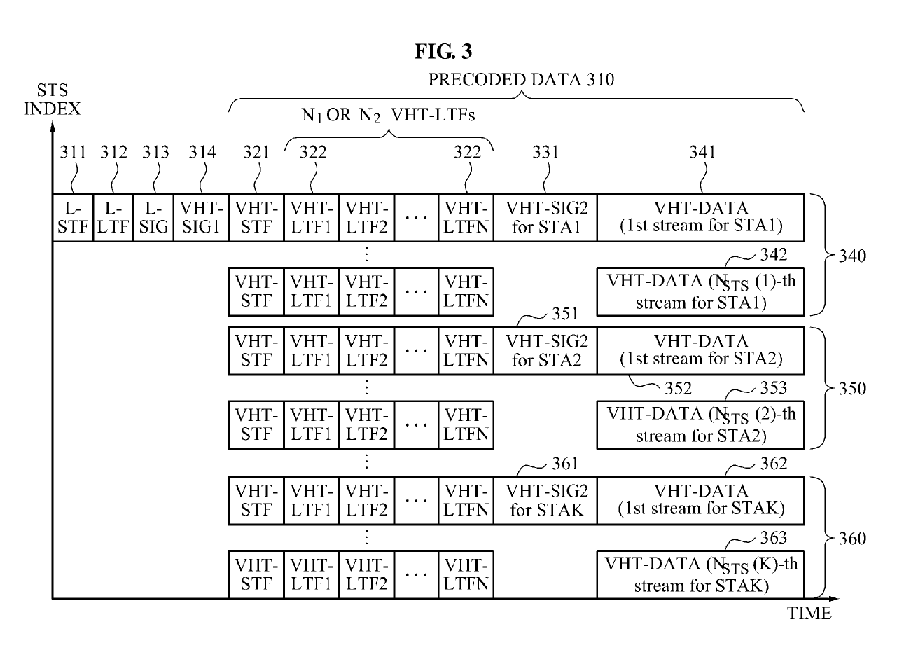

FIG. 3 is a diagram illustrating an example structure of an STS of a frame supporting MU-MIMO.

Referring to FIG. 3, K represents the total number of STAs to which a frame is transmitted, N_{STS}(i) represents the number of STSs transmitted to the i-th STA, N_{STS} represents the total number of transmitted STSs, and max N_{STS}(i) represents the maximum value in a range of N_{STS}(1) to N_{STS}(K). N₁ and N₂ represent the number of time slots of a transmitted VHT-LTF. A frame illustrated in FIG. 3 may support K number of STAs. For example, if K=3, the frame may include a first STS 340 transmitted to an STA1, a second STS 350 transmitted to an STA2, and a third STS 360 transmitted to an STA3. Each of STSs, 340, 350, and 360 may include one or more streams. Lengths of the frame transmitted to each of the STAs may be different from each other. Information about the lengths may be included in at least one field of L-SIG 313, VHT-SIG1 314, and VHT-SIG2s 331, 351, and 361, which will be further described below.

L-STF 311, L-LTF 312, L-SIG 313, and VHT-SIG1 314 may be transmitted to each of the STAs without being precoded. Each of the STAs may detect a received frame using the L-STF 311, and set a gain value of a power amplifier. Also, each of the STAs may estimate a time synchronization with respect to the received frame, and estimate a frequency offset.

Each of the STAs may accurately estimate the frequency offset using the L-LTF 312. Also, the L-SIG 313 may include information about a frame length reaching from the VHT-SIG1 314 to the end portion of the frame, so that legacy terminals may ascertain length information of a corresponding frame.

Each of the STAs may detect, using the VHT-SIG1 314, common control information with respect to a frame to be currently transmitted. The common control information may include, for example, a precoding method applied to a current frame, the number of STAs and the number of STSs which are supported by the current frame, and interval or length information and type information of the VHT-LTFs 322, or include any various parts thereof.

According to an example, the length information of the VHT-LTFs 322 may be length information of the maximum data field of the current frame.

Precoded data 310 may be precoded with respect to a specific STA, and decoded in the specific STA. The precoded data 310 included in each of the STSs 340, 350, and 360 may include a VHT-STF 321, the VHT-LTFs 322, the VHT-SIG2s 331, 351, and 361 for each STA, and VHT-DATAs 341 and 342, 352 and 353, and 362 and 363.

The VHT-STF 321 may include, for example, training signals to improve an Automatic Gain Control (AGC) performance of multiple antennas. Each of the STAs may accurately set, using the VHT-STF 321, a gain value of a power amplifier that is suitable for precoded signals.

Each of the STAs may estimate, using the VHT-LTFs 322, a channel to decode the VHT-SIG2s 331, 351, and 361 for each of the precoded STAs, and to decode the VHT-DATAs 341 and 342, 352 and 353, and 362 and 363 transmitted to each of the STAs.

A structure of the VHT-LTFs 322 may be one of Example 1 and Example 2 which are described with reference to FIGS. 1 and 2, or may be simply modified or corrected from Example 1 and Example 2. The VHT-LTFs 322 may include at least a part of the VHT-LTF sequence described in Example 1 and Example 2, and, more specifically, may include at least one row or one column of the matrix supporting each of the STAs. In particular, as described in Example 1, the VHT-LTF sequence may be configured using the same orthogonal matrix with respect to all STAs. Also, the number of rows or columns of the orthogonal matrix used to configure the VHT-LTF sequence of each of the STAs may be the same as the number of STSs transmitted to each of the STAs, and the rows or columns of the orthogonal matrix may be determined in a predetermined order. Also, as described in Example 2, all VHT-LTF sequences may be configured using mutually different rows or columns of a single orthogonal matrix.

The number N of the VHT-DATAs 341 and 342, 352 and 353, and 362 and 363 transmitted to each of the STAs may be determined in accordance with the number of transmitted STSs. Lengths of the VHT-DATAs 341 and 342, 352 and 353, and 362 and 363 transmitted to each of the STAs may be different from each other. Various methods may be used so that the frames with different lengths of the VHT-DATAs 341 and 342, 352 and 353, and 362 and 363 may be transmitted with the same length of the VHT-LTF sequences. For example, an end portion of each of the VHT-DATAs 341 and 342, 352 and 353, and 362 and 363 transmitted to each of the STAs may be padded using tail bits of an error correcting code. Also, the end portion of each of the VHT-DATAs 341 and 342, 352 and 353, and 362 and 363 transmitted to each of the STAs may further include Convolutional Code (CC) tail bits. Also, to match a basic transmission unit of the VHT-DATAs 341 and 342, 352 and 353, and 362 and 363, frame padding may be inserted. For example, in a case in which an OFDM modulation method is adopted, the basic transmission unit may be an OFDM symbol unit.

Individual control information of a frame transmitted to the STA may be detected by respectively receiving the VHT-SIG2s 331, 351, and 361 for each of the STAs. The individual control information may include length information of the VHT-DATAs 341 and 342, 352 and 353, and 362 and 363 transmitted to a corresponding STA, modulation and coding method information applied to the VHT-DATAs 341 and 342, 352 and 353, and 362 and 363, a bandwidth of a used channel, channel smoothing related information, channel aggregation related information, the error correcting code, a length of a guard interval, information related to a precoding method applied to the current frame, or any combination of one or more of these and other like information. The VHT-SIG2s 331, 351, and 361 may include the individual control information for each STA.

The STA1 may decode the precoded data 310 included in the first STS 340, the STA2 may decode the precoded data 310 included in the second STS 350, and the STA3 may decode the precoded data 310 included in the third STS 360.

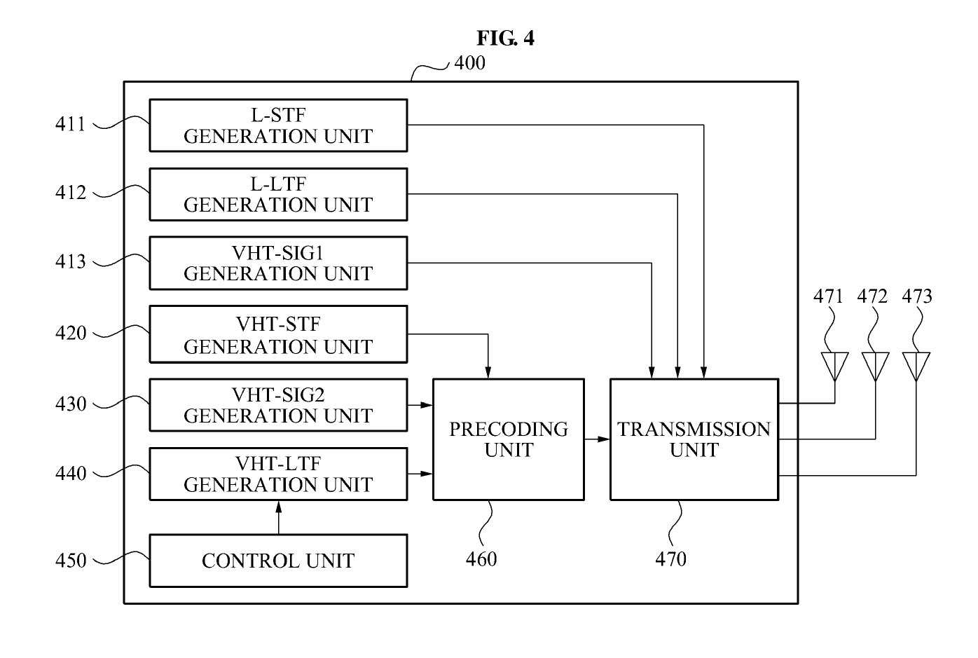

FIG. 4 is a block diagram illustrating an example structure of a data transmission apparatus. The data transmission apparatus 400 may be an AP according to IEEE 802.11 ac.

The data transmission apparatus 400 may include an L-STF generation unit 411, an L-LTF generation unit 412, a VHT-SIG1 generation unit 413, a VHT-STF generation unit 420, a VHT-SIG 2 generation unit 430, a VHT-LTF generation unit 440, a control unit 450, a precoding unit 460, and a transmission unit 470. The data transmission apparatus 400 may further include an L-SIG generation unit (not illustrated) to support a legacy terminal.

The L-STF generation unit 411 may generate an L-STF. An STA may detect a frame transmitted from the data transmission apparatus 400 using the L-STF included in the frame. The STA may match, using the L-STF, a time synchronization with respect to the current frame, or estimate an approximate frequency offset.

The L-LTF generation unit 412 may generate an L-LTF. The STA may accurately estimate the frequency offset using the L-LTF, or receive common control information that is not precoded.

The VHT-SIG1 generation unit 413 may generate a VHT-SIG1 including common control information with respect to the STAs. For example, the common control information may be control information transmitted to all STAs that are positioned within a coverage of the data transmission apparatus 400, and may be transmitted without being precoded. The common control information may include common control information with respect to a frame. The common control information may include a precoding method applied to the current frame, a number of STAs supported by a frame, information about training signals, length information of the maximum data field of the current frame, and the like.

The VHT-STF generation unit 420 may generate a VHT-STF. The STA may perform a multi-antenna Automatic Gain Control (AGC) using the VHT-STF.

The VHT-SIG2 generation unit 430 may generate a VHT-SIG2 including individual control information with respect to each of the STAs. For example, the individual control information may be control information that is individually determined in accordance with each of the STAs, and may include length information of the VHT-DATA transmitted to a corresponding STA, modulation and coding method information applied to the VHT-DATA, a bandwidth of a used channel, channel smoothing related information, channel aggregation related information, an error correcting code, a length of a guard interval, information related to a precoding method applied to the current frame, or any combination of one or more of these and other like information.

The VHT-LTF generation unit 440 may generate a VHT-LTF used to estimate a channel for each STA. A structure of the VHT-LTF may be similar to those of Example 1 and Example 2 which are described with reference to FIGS. 1 and 2, or may be simply modified or corrected from Example 1 and Example 2. A number N of VHT-DATAs transmitted to each STA may be determined in accordance with the number of transmitted STSs.

The control unit 450 may determine the number of STSs transmitted to each STA, and determine the number N of the VHT-DATAs included in each STS, based on the number of STSs.

The precoding unit 460 may generate precoded data by precoding the individual control information and data with respect to each terminal. The precoded data may be transmitted to all terminals, however, each terminal may decode only the precoded data that is precoded for that respective terminal.

The precoding unit 460 may generate the precoded data by precoding the VHT-STF, the VHT-SIG2, and the VHT-LTF which are respectively generated in the VHT-STF generation unit 420, the VHT-SIG2 generation unit 430, and the VHT-LTF generation unit 440.

The transmission unit 470 may transmit at least one STS to at least one STA through at least one transmission antenna 471, 472, and 473.

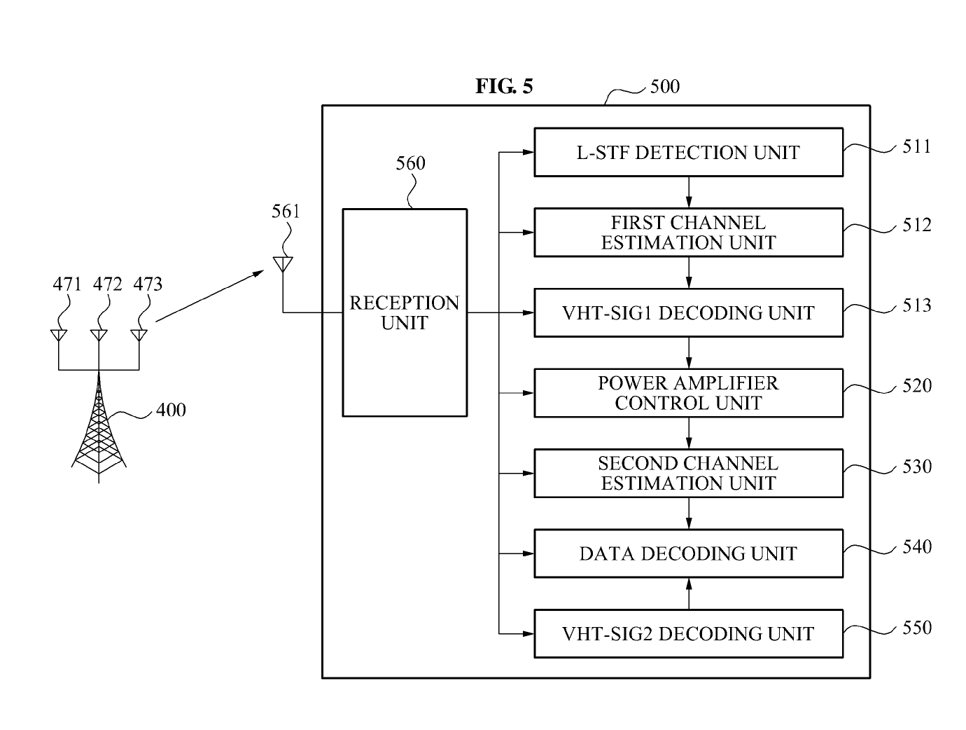

FIG. 5 is a block diagram illustrating an example structure of an STA.

The STA 500 may include a reception unit 560, an L-STF detection unit 511, a first channel estimation unit 512, a VHT-SIG1 decoding unit 513, a power amplifier control unit 520, a second channel estimation unit 530, a data decoding unit 540, and a VHT-SIG2 decoding unit 550.

The reception unit 560 may receive a frame from the data transmission apparatus 400 through at least one reception antenna 561. The frame may include an STS. The STS may include an L-STF, an L-LTF, a VHT-SIG1, and precoded data. The data transmission apparatus 400 may transmit the STS to the STA 500 using the at least one transmission antenna 471, 472, and 473.

The L-STF detection unit 511 may detect, from the L-STF, signals transmitted in the data transmission apparatus 400. The L-STF detection unit 511 may perform an approximate AGC by reading the L-STF, estimate an approximate frequency offset, and match a time synchronization with respect to the current frame.

The first channel estimation unit 512 may accurately estimate the frequency offset by reading the L-LTF. Also, the first channel estimation unit 512 may estimate a channel to decode common control information, in response to the STA 500 being a legacy terminal.

The VHT-SIG1 decoding unit 513 may decode the VHT-SIG1 including the common control information. The common control information may be control information transmitted to all STAs positioned within a coverage of the data transmission apparatus 400, and may include a precoding method applied to the current frame, the number of STAs and the number of STSs which are supported by the current frame, interval or length information and type information of the VHT-LTF, or any combination of one or more of these and other like information.

The power amplifier control unit 520 may accurately control a gain of the power amplifier by reading the VHT-STF.

The second channel estimation unit 530 may estimate a channel between the data transmission apparatus 400 and the STA 500 by reading the VHT-LTF. A structure of the VHT-LTF may be similar to one of Example 1 and Example 2 which are described with reference to FIGS. 1 and 2, or may be simply modified or corrected from Example 1 and Example 2. A number N of VHT-DATAs transmitted to each STA may be determined in accordance with the number of transmitted STSs.

The VHT-SIG2 decoding unit 550 may decode individual control information included in the VHT-SIG2. The individual control information may be control information that is individually determined in accordance with each STA, and may include information of the VHT-DATA transmitted to a corresponding STA, modulation and coding method information applied to the VHT-DATA, a bandwidth of a used channel, channel smoothing related information, channel aggregation related information, the error correcting code, a length of a guard interval, information related to a precoding method applied to the current frame, or any combination of one or more of these and other like information.

The data decoding unit 540 may decode data included in the STS, using a channel estimation result of the second channel estimation unit 530 and the individual control information decoded in the VHT-SIG2 decoding unit 550.

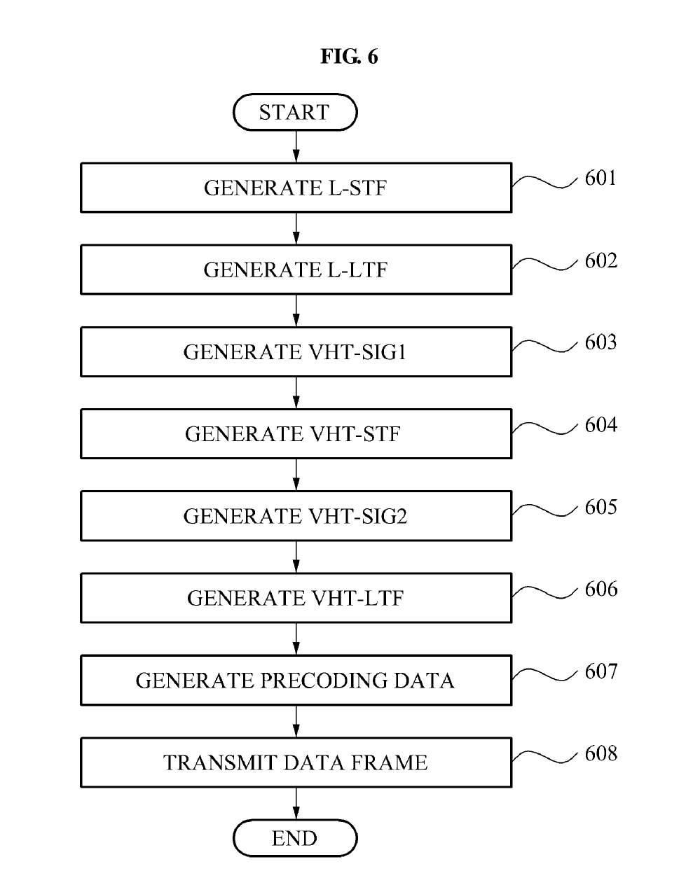

FIG. 6 is a flowchart illustrating an example data transmission method of a data transmission apparatus.

In operation 601, the data transmission apparatus may generate L-STF information to be recorded in an L-STF. An STA may detect a frame that is transmitted from the data transmission apparatus by reading the L-STF included in the frame, estimate an approximate frequency offset, and match a time synchronization with respect to a current frame.

In operation 602, the data transmission apparatus may generate L-LTF information to be recorded in an L-LTF. The STA may estimate a channel by reading the L-LTF, and decode, using a result of the channel estimation, information that is not precoded.

In operation 603, the data transmission apparatus may generate VHT-SIG1 information to be recorded in a VHT-SIG1. Common control information included in the VHT-SIG1 may include control information about a frame transmitted from the data transmission apparatus.

In operation 604, the data transmission apparatus may generate VHT-STF information to be recorded in a VHT-STF. The STA may accurately perform an AGC using the VHT-STF information.

In operation 605, the data transmission apparatus may generate VHT-SIG2 information to be recorded in a VHT-SIG2. Individual control information included in the VHT-SIG 2 may be control information that is individually generated in accordance with each STA.

In operation 606, the data transmission apparatus may generate VHT-LTF information to be recorded in a VHT-LTF. The STA may estimate a channel by reading the VHT-LTF, and decode precoded signals or precoded information using a result of the channel estimation.

In operation 607, the data transmission apparatus may generate precoded data by precoding the information generated in operations 604 to 606 and the data transmitted to each STA.

In operation 608, the data transmission apparatus may transmit, to at least one STA, a frame including the information generated in operations 601 to 603 and the precoded data generated in operation 607. The data transmission apparatus may transmit the frame in an MU-MIMO method.

In FIG. 6, operations in which each field is generated are described for convenience of description, however, the operations need not follow the described sequence.

As a non-exhaustive illustration only, a terminal or terminal device described herein may refer to mobile devices such as a cellular phone, a personal digital assistant (PDA), a digital camera, a portable game console, an MP3 player, a portable/personal multimedia player (PMP), a handheld e-book, a portable lab-top PC, a global positioning system (GPS) navigation, and devices such as a desktop PC, a high definition television (HDTV), an optical disc player, a setup box, and the like capable of wireless communication or network communication consistent with that disclosed herein.

The methods described above may be recorded, stored, or fixed in one or more non-transitory computer-readable storage media that includes program instructions to be implemented by a computer to cause a processor to execute or perform the program instructions. The media may also include, alone or in combination with the program instructions, data files, data structures, and the like. The media and program instructions may be those specially designed and constructed, or they may be of the kind well-known and available to those having skill in the computer software arts. Examples of non-transitory computer-readable media include magnetic media such as hard disks, floppy disks, and magnetic tape; optical media such as CD-ROM disks and DVDs; magneto-optical media such as optical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations and methods described above, or vice versa.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A data transmission apparatus, which enables at least one Very High Throughput-Long Training Field (VHT-LTF) sequence to be included in at least one Space Time Stream (STS) transmitted to at least one terminal, and transmits the at least one VHT-LTF sequence, the at least one VHT-LTF sequence having a same length as another VHT-LTF sequence simultaneously transmitted.

2. The data transmission apparatus of claim 1, wherein the at least one VHT-LTF sequence is configured using a same orthogonal matrix with respect to the at least one terminal.

3. The data transmission apparatus of claim 1, wherein the at least one VHT-LTF sequence is generated using an orthogonal matrix satisfying a predetermined condition, and a number of rows of the orthogonal matrix and/or a number of columns of the orthogonal matrix is the same as a number of the at least one STS transmitted to each of the at least one terminal.

4. The data transmission apparatus of claim 2, wherein rows of the orthogonal matrix and/or columns of the orthogonal matrix are created in a predetermined order.

5. The data transmission apparatus of claim 1, wherein the at least one VHT-LTF sequence is generated using an orthogonal matrix satisfying a predetermined condition, and the at least one VHT-LTF sequence is generated using rows of the orthogonal matrix and/or columns of the orthogonal matrix.

6. The data transmission apparatus of claim 1, wherein the at least one STS further includes a VHT-signal (VHT-SIG) field classified for each of the at least one terminal, and the VHT-SIG field is precoded in a Space Division Multiple Access (SDMA) method.

7. The data transmission apparatus of claim 6, wherein the VHT-SIG field includes length information of a data field included in the at least one STS transmitted to the at least one terminal.

8. The data transmission apparatus of claim 1, wherein the at least one STS further includes frame padding to adjust a basic transmission unit of a data field.

9. The data transmission apparatus of claim 1, wherein the at least one STS further includes a VHT-SIG field to be common to the at least one terminal, and the VHT-SIG field includes length information of the VHT-LTF sequence.

10. The data transmission apparatus of claim 1, wherein the at least one STS further includes a Legacy signal (L-SIG) field to be common to the at least one terminal, and the L-SIG field includes length information of a frame subsequent to the L-SIG field.

11. A method of communication used by a transmitter and terminals, the method comprising:
generating one or more streams for each of the terminals, each stream including Very High Throughput-Long Training Fields (VHT-LTFs) and a data field, at least one of the one or more streams for each of the terminals including a Very High Throughput-Signal (VHT-SIG) field having length information of the data field; and
transmitting to each of the terminals the one or more streams for each of the terminals.

12. The method of claim 11, wherein a length of the VHT-LTFs in each stream is the same.

13. The method of claim 11, wherein the VHT-LTFs, the VHT-SIG, and the data field are precoded using a Space Division Multiple Access Method.

14. A method of communication used by a terminal in a multi-user multi-input multi-output system, the method comprising:
receiving one or more streams from a transmitter, each stream including Very High Throughput-Long Training Fields (VHT-LTFs) and a precoded data field, at least one of the one or more streams including a Very High Throughput-Signal (VHT-SIG) field having length information of the data field; and
decoding the precoded data field of each stream using the VHT-LTFs and the VHT-SIG.

15. The method of claim 14, wherein a length of the VHT-LTFs in each stream is the same.

16. The method of claim 14, wherein the VHT-LTFs and the VHT-SIG are precoded.

17. A data transmission apparatus, comprising:
a generation unit to generate at least one Very High Throughput-Long Training Field (VHT-LTF) sequence to be included in at least one Space Time Stream (STS) transmitted to at least one terminal; and
a transmission unit to simultaneously transmit the at least one STS in a plurality of STSs;
wherein the at least one VHT-LTF sequence has a same length as another VHT-LTF sequence included in another STS of the transmitted plurality of STSs.

18. The data transmission apparatus of claim 17, wherein the at least one STS further includes frame padding to adjust the length of the at least one VHT-LTF sequence.

19. A method of communicating between a transmitter and a plurality of terminals, the method comprising:
generating, at the transmitter, one or more streams to be transmitted to each of the respective terminals;
wherein each stream includes a same length of Very High Throughput-Long Training Fields (VHT-LTFs).

20. The method of claim 19, wherein the VHT-LTFs are precoded using the Space Division Multiple Access Method.
